(19) United States
(12) Patent Application Publication
(10) Pub. No.: US 2014/0011575 A1
(43) Pub. Date: Jan. 9, 2014

(54) PEER-TO-PEER BETTING SYSTEMS AND METHODS

(71) Applicants: Jason Neubauer, San Francisco, CA (US); Nils Lahr, Snoqualmie, WA (US)

(72) Inventors: Jason Neubauer, San Francisco, CA (US); Nils Lahr, Snoqualmie, WA (US)

(21) Appl. No.: 13/933,384

(22) Filed: Jul. 2, 2013

Related U.S. Application Data
(60) Provisional application No. 61/667,784, filed on Jul. 3, 2012.

(51) Int. Cl. G06Q 50/34

(52) U.S. Cl. CPC G06Q 50/34
USPC 463/25

(57) ABSTRACT

Systems, methods, means and computer program products for initiating, tracking, resolving, and reporting information pertaining to bets among two or more users over a communication network are disclosed. Certain systems, methods, means and computer program products may permit users to create and modify bet parameters, and may report bet parameters and results to other users.

### CROSS REFERENCE TO RELATED APPLICATIONS

This application claims priority under 35 U.S.C. §119(e) to co-pending U.S. Provisional Patent Application Ser. No. 61/667,784, filed Jul. 3, 2012, entitled PEER-TO-PEER BETTING SYSTEM, the content of which is hereby incorporated by reference herein in its entirety for all purposes. This application further claims priority under 35 U.S.C. §119(e) to co-pending U.S. Provisional Patent Application Ser. No. 61/708,540, filed Oct. 1, 2012, entitled PEER-TO-PEER BETTING SYSTEMS AND METHODS, the content of which is hereby incorporated by reference herein in its entirety for all purposes.

### FIELD

The disclosure relates generally to systems and methods for administering bets among two or more users over a communication network.

### BACKGROUND

Brick and mortar betting institutions are known. Such institutions lack functions and features to permit customizable, on-demand bets among users with respect to any type of unsettled matter, where any type of payment can be used to settle the bet upon completion of the unsettled matter. Such institutions further lack web-based or local-area-network-based communications that link geographically-remote or co-located users in a manner that permits customizable, on-demand bets among those users.

### SUMMARY

In accordance with the disclosure, systems, methods, means and computer program products may carry out the following steps: receive parameters of a proposed bet sent from a first mobile device operated by a first user; receive an identifier of a second user sent from the first mobile device; cause the parameters of the proposed bet to be sent to a second mobile device operated by the second user; receive information indicating whether the second user agrees to the parameters from the second mobile device; and cause the information indicating whether the second user agrees to the parameters to be sent to the first mobile device.

### DRAWINGS

The present application may be more fully appreciated in connection with the following detailed description taken in conjunction with the accompanying drawings:

FIG. 1 depicts a system for administering peer-to-peer betting.

FIG. 2 illustrates a process relating to the system of FIG. 1.

FIG. 3 illustrates a process relating to the system of FIG. 1.

### DETAILED DESCRIPTION

Disclosed may be a peer-to-peer platform for initiating, tracking, resolving, and reporting information pertaining to bets between two or more people over a communication network (e.g., using wired and wireless networks, direct or indirect communication pathways without or with intermediate devices, and other means for communicating information).

Certain aspects of the disclosure relate to exchanging bet parameters between two or more users. The exchange of bet parameters may by managed using a processor that resides at a user device, or that is hosted in a location that is remote to the users. Communication of the parameters among users may be carried out with or without intermediary devices (e.g., a server in a remote location with respect to the users). Accordingly, a backend processor (e.g., server) may carry out any of the features described herein. Similarly, any combination of the user devices may carry out any of the features described herein.

Other aspects relate to creation, transmission, and management of bet parameters that specify one or more customizable payments by and for each user in relation to potential outcomes of one or more unsettled matters (e.g., future or ongoing events, undertakings, endeavors, happenings, activities or other things of a currently indeterminable nature). The payment may be different for different users, where one user may receive a payment upon winning that is different than the payment another user would have received had that other user won. Other aspects relate to modification of bet parameters by any of the users. Such modifications may change the payment(s), the unsettled matter, the potential outcome(s) of the unsettled matter, or other parameters. Other aspects relate to providing bet parameters, bet outcomes, and other information to third party users. Such information may be provided via various means, including social media websites (e.g., Facebook, Twitter, and others), or web-based sources. Still, other aspects relate to generating suggested bet parameters based on user location(s). Where two users are co-located, suggested parameters may include a suggested unsettled matter on which the users may place bets, where the unsettled matter is co-located with or nearby the users. As used here, “location” refers to a geographically confined area (e.g., a building, a location, a landmark, a neighborhood, and others).

### Example Systems and Apparatuses

In accordance with certain aspects of the disclosure, a peer-to-peer betting system may be 100 may be configured to include a communication platform 110, a first user platform 120, a second user platform 130, and a bet management platform 150. The term “platform” as used herein refers to a grouping of components designed to perform particular tasks and includes both distributed components across multiple locations and centralized components in a single location. A platform may further include components that may be hosted by or services that may be offered by parties other than those directly associated with each platform. A platform may further include hardware, software and other components configured to exchange and process data and instructions using various protocols across various network communication pathways. Certain aspects of each platform may be described in more detail below; however, the description herein may be not intended to be limiting, and alternative embodiments may be contemplated as understood by one of skill in the art.

### Communication Platform 110

The communication platform 110 may be configured to provide communication links among the various platform 120-170. For example, the communication platform 110 may utilize any one or combination of known communication networks and connections to facilitate communication in the betting system 100, including the Internet, private networks, local area networks (e.g., Wi-Fi), Bluetooth, cellular or other over-the-air wireless carrier interfaces, and other wired and wireless communication pathways. Any communication network may be utilized alone or in combination to facilitate a bet between users.

In accordance with certain aspects of the disclosure, the betting system 100 may be implemented using SMS messages or application-driven data transmissions using mobile telecommunications networks. Other transmission types (e.g., emails, web-based input/output interfaces) are contemplated using other networks (e.g., the Internet). Combinations of transmission types and networks associated with multiple users are also contemplated (e.g., use of a web-based application on a first user's computing device to initiate bet parameters, and use of a SMS message on a second user's computing device to accept or modify the bet parameters).

### User Platforms 120, 130 and 140

The user platforms 120-140 may be configured to provide bet configuration, interaction, and access to bet information to users of the betting system 100. Particularly, the first user platform 120 may be configured to allow a user to initiate a bet and configure parameters of the bet. The second user platform 130 may be configured to receive bet information (e.g., the bet parameters) directly from the first user platform 120 or via another platform, to allow a user to configure new parameters or modify parameters configured at the first user platform 120, and to receive information concerning any bet associated with the user of the second user platform 130 or with other users of other user platforms (not shown) in the system 100. The third user platform 140 may be configured to view information about the bet between a first user of the first user platform 120 and a second user of the second user platform 130. Viewing may be on a social network.

The user platforms 120-140 may be configured to operate on any suitable devices that can communicate over the communication networks of the communication platform 110. For example, the user platforms 120-140 may be configured on any of numerous general purpose or special purpose computing system environments or devices such as desktop computers, tablets, laptops, cellular phones (e.g., those with SMS and/or Internet capability), portable gaming systems, and other networked computing devices. Moreover, the betting system 100 may facilitate the communication and betting between users devices of different types of platforms 120-140.

The user platforms 120-140 may include various components, including a display, a processor, a database, a camera, an input/output interface, and memory from which software may be executed (e.g., in a web browser). One of skill in the art will appreciate that the user platforms may include addition components.

### Bet Management Platform 150

In general, the bet management platform 150 may be configured to manage bets between various users at various platforms (e.g., platforms 120-130 or others). In accordance with one aspect of the disclosure, the bet management platform 150 may include, one or more input/output interfaces, data storage components, servers/processors or similar components, and other components that are configured to receive bet data from the first user platform 120 and/or the second user platform 130, process the bet data, distribute the bet data to various platforms (e.g., user platforms 120-140, social network platform 160), access information about the location platform 170, generate suggested bet parameters (e.g., payment, unsettlement matter that users are betting on, and others).

One of skill in the art will appreciate that some or all of the functionality (e.g., data input/output, computations and other processing, storage, etc.) of the bet management platform 150 may be performed at the user platform 120, or combinations of user platforms 120 and 130, and the bet management platform 150. Similarly, third party platforms (not shown) may carry-out some or all of the functionality of the bet management platform 150. Moreover, aspects of the bet management platform 150 may be performed at the user platforms 120 and/or 130, and then data relating to bets may be uploaded to the bet management platform during the bet initiation, after the bet initiation, or after the final outcome of the bet.

### Social Network Platform 160

The social network platform 160 may take various forms. For example, the social network platform 160 may include web server(s) that host a social network website (e.g., Facebook, Twitter) to which user devices may connect in order to obtain social network information. Users may direct their user devices to access bet parameters, bet outcomes and other information disclosed herein.

### Location Platform 170

The location platform 170 may take various forms. For example, it may be a location at which one or more users reside, at which an unsettled matter is occurring, and/or at which payment is carried out. In some implementations, the location is geographically confined. For example, the location may be a building, a maximum distance from the user(s), a venue (e.g., an outdoor sporting event), a neighborhood, or other geographic area with definable boundaries. The location may be configured with a local area network through which users are connected, and through which a representative of or other party at the location may send information (e.g., suggested bet parameters) to a user. Identifying information about the location may be used to generate a list of one or more unsettled matters on which users may place bets. Such unsettled matters may be occurring at the location (e.g., a game between two users at a residence or a commercial establishment like a bar). Identifying information about the location may further be used to suggest payment options. For example, a type payment that can be redeemed at a location may be suggested where a user is near or at that location. The location of a user may also be used to identify other co-located users that are interested in wagering with the user.

### Example Processes

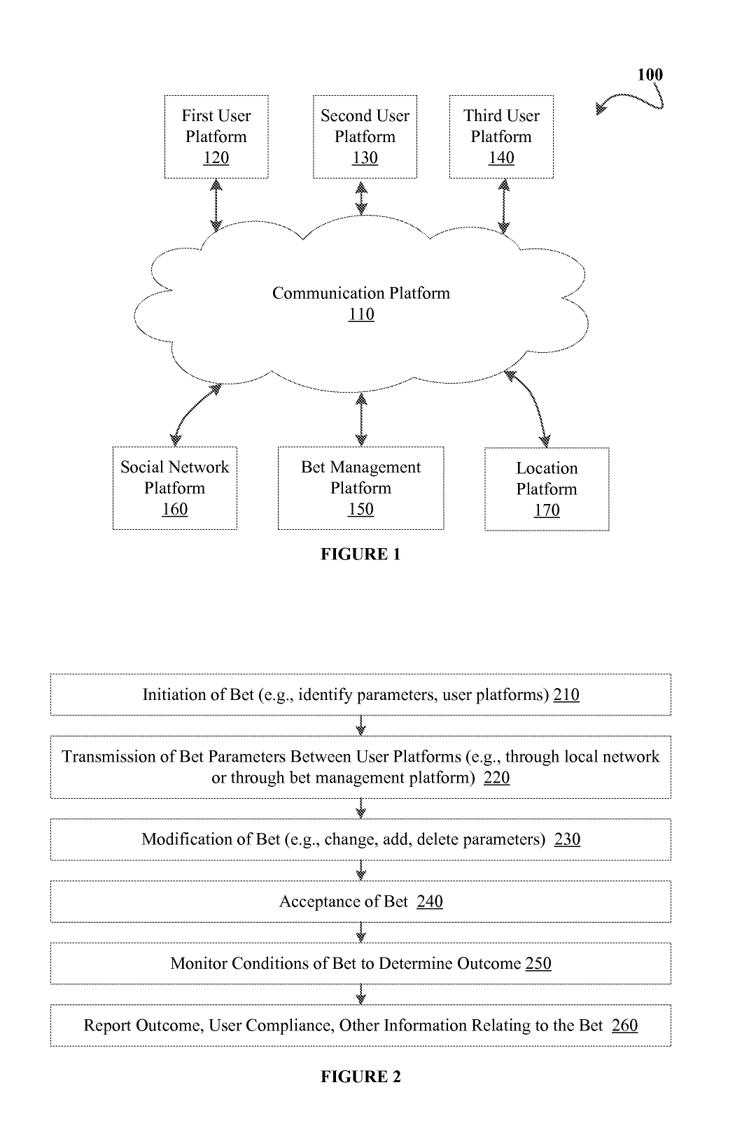

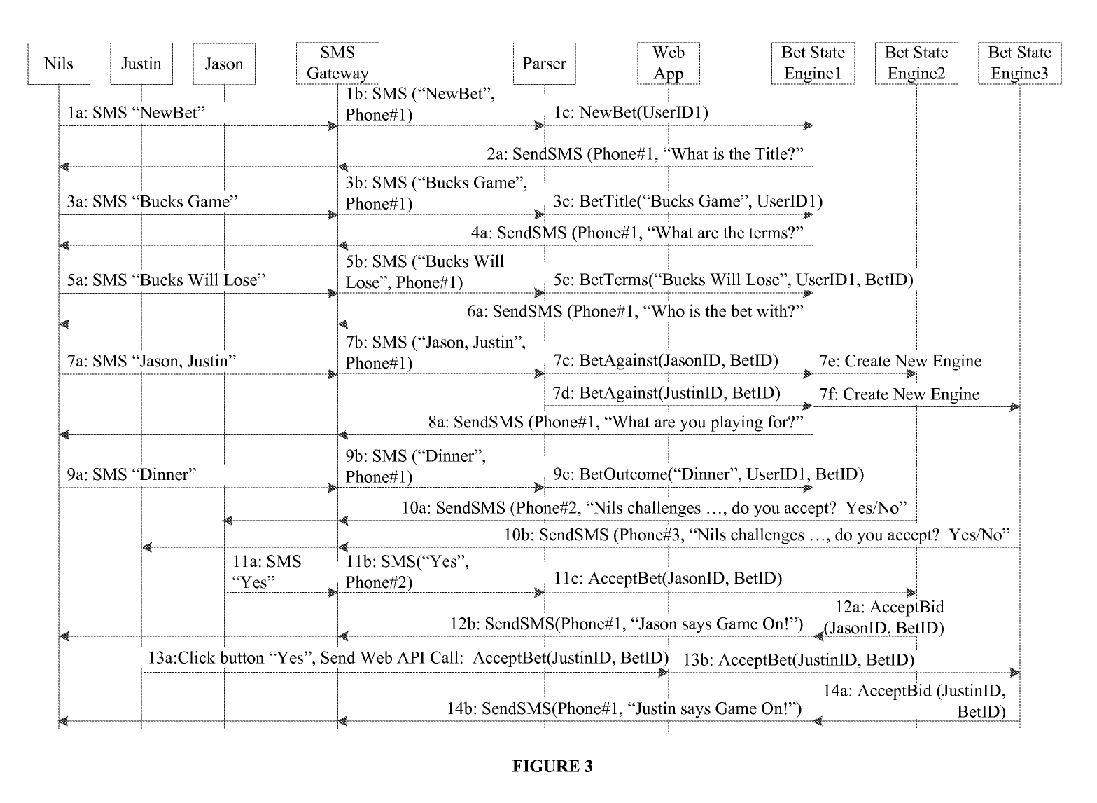

Examples of processes for initiating and managing bets between or among multiple users of user platforms are described in more detail below with respect to FIG. 2 and FIG. 3. FIG. 2 illustrates a high-level process flow diagram detailing a process for initiating and managing a bet between at least two users (e.g., using the betting system 100 of FIG. 1).

At step 210, a bet is initiated. For example, a user of the first user platform 120 may initiate the bet by identifying parameters of the bet. The parameters may be optionally suggested to the user. Example parameters may include parties to the bet (e.g., identified by cell phone number, email address, social media username, profile username, etc.), description of the bet, terms of the bet, outcome of the bet for the winner, etc. Parties to a bet may include an individual, an organization, a group of individuals, and other parties. The initiation may occur using various computing devices, including mobile computing devices connected to a telecommunications network and/or a local area network. A SMS/text message interface may be used to receive inputs from a user specifying the bet parameters. Alternatively, the bet parameters may be captured via a local software application (e.g., a mobile “app”) running on the computing device, or may be captured through websites using a web browser.

At step 220, bet parameters may be transmitted through the bet system 100 (e.g., to the second user platform 130, to the bet management platform 150). Depending on the implementation, subsequent exchanges of information between the first user platform 120 and the second user platform 130 and/or the bet management platform 150 may occur to capture all initial bet parameters. FIG. 3 illustrates a series of such subsequent exchanges between users of user platforms and a bet management platform.

In accordance with one aspect of the disclosure, a QR code (or other suitable code, image, keyword, object etc.) may be created and associated with bet parameters. A user of the second user platform 130 may scan the QR code or otherwise capture the other suitable text, image, object) to obtain access to the bet parameters.

At step 230, modifications to the bet are optionally received from the first user platform 120 and/or the second user platform 130 during a “virtual negotiation.” Denial of the bid is also contemplated. Exchanges of such modifications between user platforms 120 and 130 may occur for any period of time, may be limited to a predefined number of exchanges, may be limited to a time period prior to an identified outcome, or may otherwise be administered. Modifications may be exchanged directly between users of user platforms 120 and 130 using peer-to-peer transmission technologies, or may pass through the bet management platform 150 or other platform (e.g., social network platform 160 or location platform 170).

At step 240, when the current bet parameters are acceptable to involved parties, the bet is accepted. The bet parameters may be stored locally at a user platform (e.g., for later upload to the bet management system 150) and/or may be stored at the bet management platform 150. Additionally, acknowledgement of the bet may be posted on various social media outlets (e.g., via social network platform 160).

At step 250, one or more platforms of the bet system 100 may monitor conditions in order to determine the outcome of the bet. An indication of the outcome may be automatically determined by the one or more platforms, or may be determined using input by a user (e.g., one of the parties to the bet, or a third party who agreed to confirm or judge the outcome). Certain outcomes may be automatically determined using third party resources (e.g., sports scores, other publicized outcomes).

At step 260, one or more platforms of the bet system 100 may report the outcome of the bet, user compliance in relation to the underlying agreement of the bet, and/or other information relating to the bet. Reports may be delivered to user platforms, websites associated with parties to the bet, or elsewhere. User compliance may be represented by a reliability score, credibility rating, an indication of fulfillment or lack of fulfillment of agreed upon terms, or other indication of compliance. Stored information regarding the bet may be updated to reflect the outcome and user compliance.

By way of illustration and not limitation, various content (e.g., video, photos, audio, text, etc.) may be stored as bet data, used to determine and outcome (e.g., other users may vote for a winner based on the content), and accessed at a later time. Tracking of bets for particular users, bets of a particular kind across many users, or other metrics is further contemplated. Past bet information may be searchable, correlated against other bet information, or otherwise used to enhance user experience.

Attention may be now drawn to FIG. 3, which illustrates an exemplary process diagram of a betting system using the short-message-service (“SMS”) protocol on wireless telecommunication networks. Alternatively, or additionally, a web interface may be used. For simplicity, an SMS gateway, as used below may represent any or all of an SMS, web or other transmission protocols.

FIG. 3 describes the process of a prototypical system among three users (Nils, Justin and Jason) in accordance with at least one embodiment of the disclosure. According to process steps 1a-1c, a user Nils initiates a new bet from his mobile device. The new bet may be regarding any subject matter, personal or otherwise. For example, the bet may be concerning a game of beer pong, social interactions between friends, or simply a sports wager. For simplicity, the bet described in FIG. 3 may be friendly wager on a football game.

Using an SMS gateway via a communication network (step 1b), Nils may be able to initiate the new bet (step 1c). Once initiated, the Parser analyzes the unstructured input English language input and converts or maps it to an output (step 1b). In this example, the Parser takes an English language input and converts it using the Bet API. Particularly, the Parser deciphers the SMS message “New Bet” as a command to initiate a new bet and return a command “NewBet(UserID1)” to the Bet State Engine 1 (step 1c).

Once initiated, the Bet State Engine 1 sends a SMS response to Nils to grab further appropriate data concerning the new bet. Here, the Bet State Engine responds to initiation by requesting a title/description from Nils using the SMS gateway (step 2a). At step 3a, Nils may respond to the inquiry with appropriate responses concerning the particulars of the new bet. Here, the Bet State Engine 1 sends an SMS message to Nils requesting the title of his new bet (step 2a). Nils response, “Bucks Game” using the SMS gateway (step 3b), may be analyzed by the Parser and converted using the Bet API to “BetTitle (“Bucks Game”, UserID1)” (step 3c).

Although not shown, the Bet Stage Engine 1 may also analyze the bet title to determine the subject matter, which can be used to identify other sources of information relating to the status and outcome of the subject matter. For example, the title “Bucks game” could be used to identify an ongoing or future sporting “game” involving a team referred to as the “Bucks”. One or more possible games may be identified, and the Bet State Engine may ask Nils to confirm the particular game on which he would like to initiate a bet. By confirming the game, the Bet State Engine may then track the progress of the game without further interaction from Nils or another user, and may transact any payment automatically between Nils and the other counterpart to the bet upon final outcome of the game. Similar text analysis and confirmation requests may be applied to other information/data transmitted between users (e.g., Nils) and the bet platform (e.g., bet state engine).

Steps 4-5 generally repeat this process attempting to acquire initial information concerning the new bet. Similarly, in step 4a, the Bet State Engine 1 sends another SMS message to Nils using the SMS gateway to determine the terms of the bet. Furthermore, these messages may also include confirmations of previous inputs such as the bet title. At step 5a, Nils responds through the SMS gateway with the terms of his bet. In this example, “Bucks will lose” may be the terms of Nils bet which may be communicated to the Parser and in turn converted using the Bet API to “BetTerms(“Bucks will lose”, UserID, BetID). Steps 4-5 may be repeated until all the initial information required for the bet has been successfully transmitted to the Bet State Engine 1 and may be not limited to only Bet Title and Bet Terms as described in the figure.

Once the Bet State Engine 1 confirms the appropriate terms of the bet, the Engine will attempt to ascertain with whom the bet may be being placed. As shown, bets may be placed with a single or with multiple users. Particularly, at step 6a the Bet State Engine 1 sends a message to Nils using the SMS gateway requesting “Who is the bet with.” Nils responds by sending a message listing the users which he wishes to make the bet with (step 7b). Here, Nils lists “Jason & Justin” as the opponents and this information may be analyzed by the Parser and converted (step 7b-d). The names may be associated with Nils (e.g., a profile of Nils, contacts of Nils), or may be searched for in a database. Confirmation (not shown) of the users may be performed between Nils and the bet management platform. A separate Bet State Engine may be created for each pair of bettors or may create a single Bet State Engine which encompasses the entire bet. In this example, separate bet engines may be created for a bet between Nils and Jason (step 7e) and a bet between Nils and Justin (step 70.

Similar to steps 4-5 described above, the Bet API ascertains what the users may be playing for and Nils responds appropriately with Dinner and this information may be saved (steps 8-9c).

Once the details of the bet have been established, the Bet State Engines 2 and 3 send appropriate SMS messages using the SMS gateway to users Jason and Justin relaying the details of the bet initiated by Nils and confirming whether or not they accept the terms of the bet (step 10a-b). In this example, Jason receives the SMS message “Nils challenges that the Bucks will lose for dinner. Do You Accept? Respond Yes or No” (step 10a). A similar message may be sent to Justin by Bet Engine 3 (step 10b). Although not shown, the terms of the bet may be declined and altered by either Jason or Justin. Because both bets have individual Bet Engines, the bets between them and Nils may end up being different. Any alteration by Jason or Justin, however, would require a similar acceptance by Nils. This negotiation of terms would continue until all terms may be agreeable to the parties of each bet.

At steps 11a-c, Jason accepts the bet by responding with “yes” and the acceptance may be established by the Bet Engine 2. At steps 12a-b, the Bet Engine 2 sends a message through the SMS gateway to Nils notifying him that Jason has accepted the bet. Similarly, steps 13a-14b describe an acceptance by Justin using a web application and an appropriate message may be sent to Nils notifying him that the bet has been accepted.

By way of further illustration, a bet may be created using the series of information/instruction exchanges depicted in FIG. 3, or using fewer exchanges. For example, a user may send a single formatted message, where various parameters are separated by a parsing indicator (e.g., “@” or “/”). For instance, a text of “[TITLE OF BET] @ [TERMS OF BET] @ [OTHER PARTY TO BET] @ [OUTCOME/PRIZE FOR WINNER],” wherein the portions may be replaced with the appropriate details, would initiate a bet.

### Additional Aspects

One or more aspects may relate to systems, methods, means and computer program products for administering bets among users. Systems may include a processing component operable to implement a method. Computer program products may include a non-transitory computer usable medium having a computer readable program code embodied therein that is adapted to be executed to implement a method.

Method steps may include: receive parameters of a proposed bet sent from a first mobile device operated by a first user; receive an identifier of a second user sent from the first mobile device; cause the parameters of the proposed bet to be sent to a second mobile device operated by the second user; receive information indicating whether the second user agrees to the parameters from the second mobile device; cause the information indicating whether the second user agrees to the parameters to be sent to the first mobile device; and cause the parameters to be displayed to a user via a social network. In accordance with some aspects, the parameters of the proposed bet include a proposed payment that depends on an outcome of an unsettled matter.

Method steps may further include: determine a winning user and a losing user from the first and second users; determine whether the losing user fulfilled the payment to the winning user; and cause an indication as to whether the losing user fulfilled the payment to the winning user to be displayed on the screen of the computing device of the third user via the social network.

Method steps may further include: receive information indicating that the second user wants to change the parameters to include a modification to the proposed payment; cause the modification to the proposed payment to be sent to the first mobile device for approval; and receive information indicating whether the first user agrees to the modification to the proposed payment from the first mobile device.

Method steps may further include: receive information indicating that the second user wants to change the parameters to replace the unsettled matter with an alternative unsettled matter; cause the alternative unsettled matter to be sent to the first mobile device for approval; and receive information indicating whether the first user agrees to the alternative unsettled matter.

Method steps may further include: determine a location of the first device or the second device; identify one or more suggested parameters based on the location; and causing the one or more suggested parameters to be sent to the first device prior to receiving the parameters of the proposed bet from the first mobile device, wherein the parameters of the proposed bet include the one or more suggested parameters. In accordance with some aspects, the one or more suggested parameters include a suggested payment related to the location, the one or more suggested parameters include a suggested unsettled matter at the location, or the one or more suggested parameters include a suggested unsettled matter between two other users at the location.

Method steps may further include: determine when the first user device and the second user device are within a threshold distance of each other; and causing the identifier of the second user associated with the second device to be sent to the first device prior to receiving identifier.

### Other Aspects

It is understood that the specific order components disclosed herein are examples of exemplary approaches. Based upon design preferences, it is understood that the specific order components may be rearranged, and/or components may be omitted, while remaining within the scope of the present disclosure unless noted otherwise. The previous description of the disclosed embodiments is provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. The disclosure is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. The various illustrative systems, methods, logical blocks, modules, circuits, and algorithm steps described herein may be implemented or performed directly in hardware, in software executed by a processor, or in a combination of the two. Accordingly, a processor may perform any one, some or all of the processing, computational and other method steps or other system functionality relating to the processes/methods and systems disclosed herein. Such processors may include a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, chip, or state machine. A processor may take different forms depending on its functionality and location (e.g., a backend server, a chip on a smart phone, any of various processors in computing devices). The term “processor” may refer to one, two or more such devices. Furthermore, a processor may be implemented as a combination of processors. It is noted that the terms “computer” or “computing device” or “user device” or the like may refer to devices that include a processor. In accordance with certain aspects of the present disclosure, one or more of the process steps described herein may be stored in memory as computer program instructions. These instructions may be executed by a processor to perform the methods described herein. Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user terminal. In the alternative, the processor and the storage medium may reside as discrete components in a user terminal. The previous description of the disclosed embodiments is provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. It is intended that the following claims and their equivalents define the scope of the disclosure. Aspects of the present disclosure are typically carried out in or resident on a computing network. The computing network generally includes computer hardware components such as servers, monitors, I/O devices, network connection devices, as well as other associated hardware. In addition, the aspects and features described herein may include one or more application programs configured to receive, convert, process, store, retrieve, transfer and/or export data and other content and information. As an example, these aspects and features may include one or more processors that may be coupled to a memory space comprising SRAM, DRAM, Flash and/or other physical memory devices. Memory space may be configured to store an operating system (OS), one or more application programs, such as a UI program, data associated with the pertinent aspect or feature, applications running on processors in the device, user information, or other data or content. The various aspects and features of the present disclosure may further include one or more User I/O interfaces, such as keypads, touch screen inputs, mice, Bluetooth devices or other I/O devices. In addition, the certain aspects and features may include a cellular or other over the air wireless carrier interface, as well as a network interface that may be configured to communicate via a LAN or wireless LAN (WiLAN), such as a Wi-Fi network. Other interfaces, such as USB or other wired interfaces may also be included. Data sources may be a hard disk drive for convenience, but this is not required, and one of ordinary skill in the art will recognize that other storage media may be utilized without departing from the scope of the invention. In addition, one of ordinary skill in the art will recognize that the data source which is depicted as a single storage device, may be realized by multiple (e.g., distributed) storage devices. It is further contemplated that the data source may include one or more types of a data sources, including hierarchical data sources, network data sources, relational data sources, non-relational data sources, object-oriented data sources, or another type of data source able to handle various data types (e.g., structured data that fits nicely into fields, rows, and columns, or data from various media sources such as graphics, photographs, audio, and video structured data. For example, the data source 132 may store data in a fixed file format, such as XML, comma separated values, tab separated values, or fixed length fields. Alternatively, the data source may store data in a non-fixed file format (e.g., a NoSQL data source). As used herein, computer program products comprising computer-readable media including all forms of computer-readable medium except, to the extent that such media is deemed to be non-statutory, transitory propagating signals.

1. A system for administering a bet over a network, the system comprising one or more computing devices operable to:
receive parameters of a proposed bet sent from a first mobile device operated by a first user;
receive an identifier of a second user sent from the first mobile device;
cause the parameters of the proposed bet to be sent to a second mobile device operated by the second user;
receive information indicating whether the second user agrees to the parameters from the second mobile device; and
cause the information indicating whether the second user agrees to the parameters to be sent to the first mobile device.

2. The system of claim 1, wherein the parameters of the proposed bet include a proposed payment that depends on an outcome of an unsettled matter.

3. The system of claim 2, wherein upon receiving information indicating that the second user wants to change the parameters to include a modification to the proposed payment, the one or more computing devices are operable to:
cause the modification to the proposed payment to be sent to the first mobile device for approval; and
receive information indicating whether the first user agrees to the modification to the proposed payment from the first mobile device.

4. The system of claim 2, wherein upon receiving information indicating that the second user wants to change the parameters to replace the unsettled matter with an alternative unsettled matter, the one or more computing devices are operable to:
cause the alternative unsettled matter to be sent to the first mobile device for approval; and
receive information indicating whether the first user agrees to the alternative unsettled matter.

5. The system of claim 2, wherein the one or more computing devices are operable to:
determine a winning user and a losing user from the first and second users;
determine whether the losing user fulfilled the payment to the winning user; and
cause an indication as to whether the losing user fulfilled the payment to the winning user to be sent to a third device via a social network.

6. The system of claim 2, wherein the one or more computing devices are operable to:
determine a location of the first device or the second device;
identify one or more suggested parameters based on the location; and
causing the one or more suggested parameters to be sent to the first device prior to receiving the parameters of the proposed bet from the first mobile device, wherein the parameters of the proposed bet include the one or more suggested parameters.

7. The system of claim 6, wherein the one or more suggested parameters include a suggested payment related to the location.

8. The system of claim 6, wherein the one or more suggested parameters include a suggested unsettled matter at the location.

9. The system of claim 6, wherein the one or more suggested parameters include a suggested unsettled matter between two other users at the location.

10. The system of claim 6, wherein the one or more computing devices are operable to:
determine when the first user device and the second user device are within a threshold distance of each other; and
causing the identifier of the second user associated with the second device to be sent to the first device prior to receiving identifier.

11. A computer program product comprising a non-transitory computer usable medium having a computer readable program code embodied therein, said computer readable program code adapted to be executed to implement a method for administering a bet among two or more users, the method comprising steps to:
receive parameters of a proposed bet sent from a first mobile device operated by a first user;
receive an identifier of a second user sent from the first mobile device;
cause the parameters of the proposed bet to be sent to a second mobile device operated by the second user;
receive information indicating whether the second user agrees to the parameters from the second mobile device; and
cause the information indicating whether the second user agrees to the parameters to be sent to the first mobile device.

12. The computer program product of claim 11, wherein the parameters of the proposed bet include a proposed payment that depends on an outcome of an unsettled matter.

13. The computer program product of claim 12, the method further comprising:
receive information indicating that the second user wants to change the parameters to include a modification to the proposed payment;
cause the modification to the proposed payment to be sent to the first mobile device for approval; and
receive information indicating whether the first user agrees to the modification to the proposed payment from the first mobile device.

14. The computer program product of claim 11, the method further comprising:
receive information indicating that the second user wants to change the parameters to replace the unsettled matter with an alternative unsettled matter;
cause the alternative unsettled matter to be sent to the first mobile device for approval; and
receive information indicating whether the first user agrees to the alternative unsettled matter.

15. The computer program product of claim 11, wherein the parameters further include a description of the bet, and wherein the method further comprises:
cause the parameters to be displayed on a screen of a computing device of a third user via a social network;
determine a winning user and a losing user from the first and second users;
determine whether the losing user fulfilled the payment to the winning user; and
cause an indication as to whether the losing user fulfilled the payment to the winning user to be displayed on the screen of the computing device of the third user via the social network.

16. The computer program product of claim 11, the method further comprising:
determine a location of the first device or the second device;
identify one or more suggested parameters based on the location; and
causing the one or more suggested parameters to be sent to the first device prior to receiving the parameters of the proposed bet from the first mobile device, wherein the parameters of the proposed bet include the one or more suggested parameters, wherein the one or more suggested parameters include a suggested payment related to the location, a suggested unsettled matter at the location.

17. A method for administering a bet among two or more users, the method comprising steps to:
receive parameters of a proposed bet sent from a first mobile device operated by a first user;
receive an identifier of a second user sent from the first mobile device;
cause the parameters of the proposed bet to be sent to a second mobile device operated by the second user;
receive information indicating whether the second user agrees to the parameters from the second mobile device; and
cause the information indicating whether the second user agrees to the parameters to be sent to the first mobile device.

18. The method of claim 17, wherein the parameters of the proposed bet include a proposed payment that depends on an outcome of an unsettled matter, and wherein the method further comprises steps to:
receive information indicating that the second user wants to change the parameters to include a modification to the proposed payment or replace the unsettled matter with an alternative unsettled matter;
cause the modification to the proposed payment to be sent to the first mobile device for approval or cause the alternative unsettled matter to be sent to the first mobile device for approval; and
receive, from the first mobile device, information indicating whether the first user agrees to the modification to the proposed payment or to the alternative unsettled matter.

19. The method of claim 17, the method further comprising steps to:
determine a location of the first device or the second device;
identify one or more suggested parameters based on the location; and
causing the one or more suggested parameters to be sent to the first device prior to receiving the parameters of the proposed bet from the first mobile device, wherein the parameters of the proposed bet include the one or more suggested parameters, wherein the one or more suggested parameters include a suggested payment related to the location, a suggested unsettled matter at the location.

20. The method of claim 17, wherein the parameters further include a description of the bet, and wherein the method further comprises steps to:
cause the parameters to be displayed on a screen of a computing device of a third user via a social network;
determine a winning user and a losing user from the first and second users;
determine whether the losing user fulfilled the payment to the winning user; and
cause an indication as to whether the losing user fulfilled the payment to the winning user to be displayed on the screen of the computing device of the third user via the social network.
